(19) United States
(12) Patent Application Publication
(10) Pub. No.: US 2008/0016999 A1
(43) Pub. Date: Jan. 24, 2008

(54) Dual-mode feed mechanism for a food slicing machine

(75) Inventors: Thomas P. Mathues, Hilliard, OH (US); William J. Locascio, Lancaster, OH (US); Paul M. Kemp, Mount Gilead, OH (US)

Correspondence Address: KREMBLAS, FOSTER, PHILLIPS & POLLICK, 7632 SLATE RIDGE BOULEVARD, REYNOLDSBURG, OH, 43068, US

(73) Assignee: J. E. Grote Company

(21) Appl. No.: 11/490,830

(22) Filed: Jul. 21, 2006

(51) Int. Cl. B26D 3/00

(52) U.S. Cl. 83/42

(57) ABSTRACT

A feed mechanism for a food slicing machine. The feed mechanism is capable of dual configurations: gripper mode and continuous feed mode. The apparatus has dual conveyors that can feed food products continuously, and a gripper mechanism that can feed food products reciprocatingly. Before engaging the continuous mode, the gripper mechanism is driven to an end of the machine and then a drive belt, which a jaw clamps during the gripper mode, is released. The dual, opposing conveyors then feed the food product that rolls to them by gravity over a moveable roller frame extending beneath the gripper mechanism. During gripper mode, the upper conveyor can be removed or raised out of the way, and the moveable roller frame is positioned just beneath the gripper. The gripper jaw clamps the drive belt and the gripper is driven in a reciprocal manner over the lower conveyor.

### BACKGROUND OF THE INVENTION

1. Field of the Invention

This invention relates generally to a feed mechanism for a food slicing machine, and more particularly relates to an apparatus that conveys food products into a moving slicing blade and can operate in a continuous feed mode or in a reciprocating gripper mode.

2. Description of the Related Art

Food slicing machines typically are made in different configurations to accommodate different types of food products that must be sliced. The basic configuration of a food slicing machine includes a moving blade that slices the food products, and a feed mechanism that conveys the food product through the moving blade's path. The feed mechanism can be a passive mechanism that uses a tube or other structure that delivers the product to the blade under the influence of gravity, or it can be an active mechanism that drives the food product through the blade.

A rotary blade slicer, such as those manufactured and sold by Weber Maschinenbau Gmbh. & Co., Breidenbach, Germany, conventionally slices with an orbital blade, which is a circular blade with a center that is offset from its axis of rotation. An orbital blade's cutting edge slices through food product during a portion of the blade's rotation, and is spaced away from the food product during the remainder of the rotation. Orbital blade slicing machines conventionally have one of two types of active feed mechanisms. The first type is a gripper feeder, which is characterized by a driven gripping head that conveys a gripped food product along a path into the blade after moveable teeth grip the food product at an end opposite the end that is sliced first. Such a machine is typically side-loading, which means the food product is placed in the machine on the side of the path the food travels to the blade and is conveyed from one end of the machine toward the blade that is near the opposite end of the machine.

Gripper feed mechanisms are typically driven by a precision drive system that indexes the gripper head and the gripped product through the blade's path at precisely timed intervals and in increments that are substantially equal to the resulting slice's thickness. The gripper indexes the gripped product while the blade is raised above the food product so that when the blade rotates along its cutting path the product is in that cutting path.

The gripper of such machines must be able to travel along the machine a distance that is equal to or greater than the longest log of product that is intended for that slicer. This can range, conventionally, from 36 to 72 inches or more, depending on many variables. The region of the machine where the product is placed prior to being advanced into the blade is often constructed with a conveyor-type belt beneath the gripper that moves with the gripper head. Alternatively, some machines support the food product on bearing-mounted rollers or polished plates that provide little resistance to motion. The conveyor or rollers are often tilted toward the slicing zone so that gravity can assist the feed mechanism. In machines built for long food logs the overall height can exceed eight feet.

When the gripped end of the food product is close to the slicing blade in machines of this type, the gripper is also close to the slicing blade, and a small piece of food product is gripped in the gripping teeth. This end piece, which can be referred to as a “heel”, cannot be sliced because it is held in the gripper teeth, and if the gripper is advanced too far, the gripper teeth will contact the slicer blade. This is avoided in most conventional machines by a computer controlling the drive motor that advances the gripper, and restricting the gripper head from advancing beyond a predetermined limit. Normally a physical limit is provided to prevent contact in case of control failure. Upon reaching that predetermined limit, the gripper is returned to a loading position where a new log of food product may be gripped. As the gripper head is returned to the loading position, the teeth can open and the remaining piece of product is released to drop through a hole formed in the machine for receipt of discarded heels.

Heels of some food products are undesirable, and these food products are often easily accommodated with a gripper slice feeder, which have the ability to “reject” the heels rather than permitting them to enter the slicing path of the blade. The gripper is also desirable for products with wide variations in cross section, such as some whole muscle meats. It is also known that some food products are not easily fed using gripper-type feed mechanisms, or it is undesirable to feed them using these mechanisms. Therefore, a second type of food product feeding mechanism has been developed. This type uses opposed conveyors, in which one conveyor is located under and the other conveyor is located over the food path. The conveyors are commonly angled toward the slicing zone to enhance feeding toward the blade.

The lower conveyor of such machines is substantially fixed in its relationship to the slicing blade, but the upper conveyor is commonly allowed to “float” vertically to allow for variation in thickness of food products. The upper conveyor is also commonly urged downward, such as by a spring, to provide a downward force on the product, thereby “pinching” the product between the conveyors for more effective feeding. The conveyors are synchronously driven to move the product held between them precisely into the slicing zone much like the gripper, but without the positive location of any part of the food product. Thus, conveyors cannot locate ends of the food product loafs for discarding.

Food products are fed into the opposed conveyors from the end of the conveyor opposite the blade. New product can be fed continuously into the feed conveyor end while slicing of already-conveyed product proceeds at the slicing end of the conveyor. As the product is indexed toward the slicing zone, space opens for new product to be introduced to the conveyors.

Food products that have ends that will be utilized can be advanced using this type of feed mechanism. Additionally, when it is desired to run the slicer continuously this type of feed mechanism is desirable. Soft or easily broken logs can be accommodated by this type of feeder since the two conveyors spread the feeding loads over a large area. This type of feed mechanism is less suited to feeding products that are highly variable in cross section.

The need exists for a feeding mechanism for a slicing machine that has the benefits of both types of feed mechanisms.

### BRIEF SUMMARY OF THE INVENTION

The invention is an apparatus for conveying food products along a food path into a blade of a food slicing machine. The apparatus comprises a lower conveyor defining a base of the food path. The lower conveyor is drivingly linked to a drive means, such as a servo motor, that drives the lower conveyor. An upper conveyor, which is preferably vertically displaceable and removably mounted to the slicing machine, is disposed above the lower conveyor. The upper conveyor is preferably removably, drivingly linked to the same motor as the lower conveyor during a continuous feed mode.

The apparatus also includes a gripper that can grip food during a reciprocating gripper mode, and means for linking the gripper to, and unlinking the gripper from, gripper drive means. Preferably the means for linking and unlinking is a clamping jaw connected to the gripper for clamping and releasing a drive belt driven by the same motor used to drive the conveyors. When the gripper clamps the drive belt, the gripper can be disposed into the food path. This occurs during a reciprocating gripper mode. During the continuous feed mode, the gripper releases the drive belt, thereby unlinking the gripper from the gripper drive means and disposing the gripper out of the food path.

In a more preferred embodiment, the apparatus has a moveable roller frame that extends from near one end of the lower conveyor to beneath the gripper during the continuous feed mode for food products to be conveyed over the moveable roller frame, into the conveyors and then fed into the blade. This permits the gripper to be disposed above the moveable roller frame and out of the food product path during continuous feed mode, but permits the gripper feed mode to be engaged simply by repositioning the moveable roller frame to the upward position, clamping the gripper to the belt and disposing the gripper in the food path again. In gripper mode, the upper conveyor is preferably either raised out of the way or removed from the apparatus.

The invention also contemplates methods of engaging the gripper mode and later converting to the continuous feed mode. The gripper mode includes the steps of disposing a lower conveyor at a base of the food path and drivingly linking the lower conveyor to means for driving the lower conveyor. Another contemplated step includes spacing an upper conveyor from the lower conveyor adjacent the food path and drivingly linking the upper conveyor to means for driving the upper conveyor. Still another step includes disposing a gripper into the food path and drivingly linking the gripper to means for driving the gripper.

The continuous feed mode method includes the step of disposing a lower conveyor at a base of the food path and drivingly linking the lower conveyor to means for driving the lower conveyor. Another step includes spacing an upper conveyor from the lower conveyor adjacent the food path and drivingly linking the upper conveyor to means for driving the upper conveyor. Still another step includes disposing a gripper out of the food path and unlinking the gripper from means for driving the gripper.

The food product feeding mechanism of the present invention is capable of operating in the continuous feed mode and the reciprocating gripper mode with a very short time required for changing modes. In the continuous feed mode, conveyors convey the food product toward a slicing blade, and the conveyors can be end or side-loaded without interference from the gripper mechanism. In the gripper mode, a gripper conveys the food product toward a slicing blade. In the gripper mode, the upper conveyor can be removed or, in certain circumstances, left in place.

### BRIEF DESCRIPTION OF THE SEVERAL VIEWS OF THE DRAWINGS

FIG. 1 is a view in perspective illustrating an embodiment of the present invention attached to a food slicing machine.

FIG. 2 is a view in perspective illustrating the embodiment of FIG. 1 from a different side.

FIG. 3 is a view in perspective illustrating an embodiment of the upper conveyor of the FIG. 1 embodiment.

FIG. 4 is a view in perspective illustrating the machine of FIG. 1.

FIG. 5 is a view in perspective illustrating the machine of FIG. 1.

FIG. 5b is a view in perspective illustrating the gripper head from the underside.

FIG. 6 is a view in perspective illustrating the machine of FIG. 1 with the gripper head mounted in an operable position.

FIG. 7 is a view in perspective illustrating a drive means of the present invention.

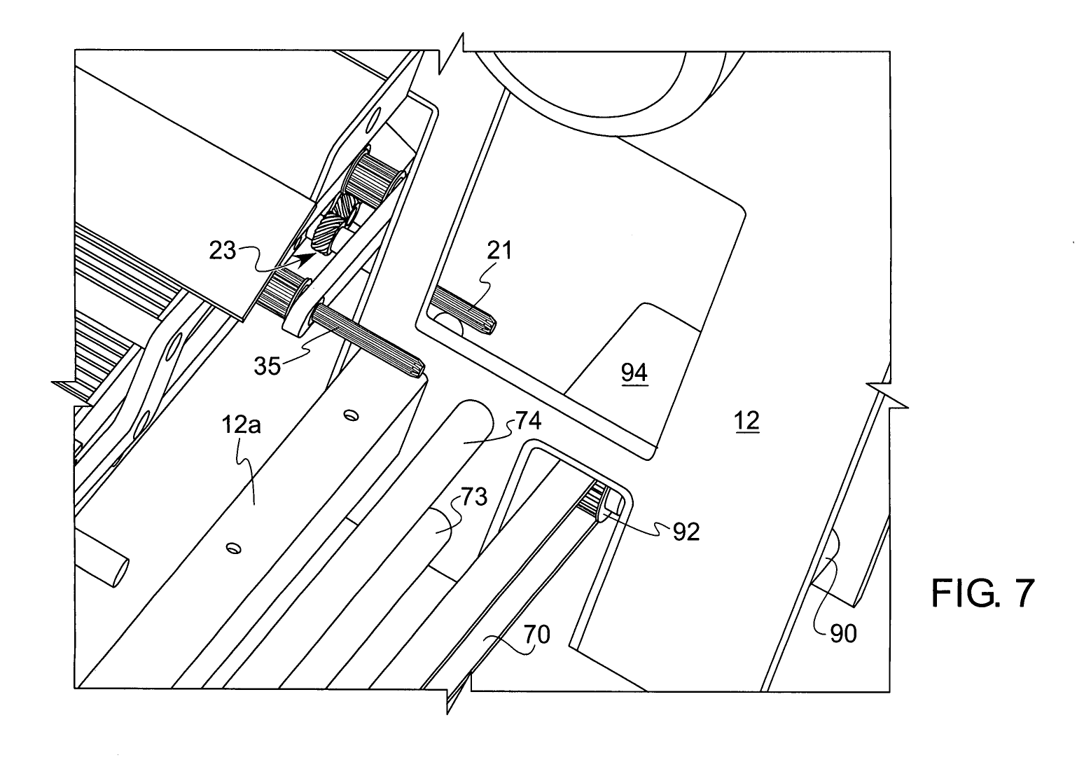

FIG. 8 is a view in perspective illustrating an alternative embodiment of the present invention in the continuous feed mode.

FIG. 9 is a view in perspective illustrating the embodiment of FIG. 8 in the gripper mode position.

FIG. 10 is a view in perspective illustrating an alternative embodiment of the upper conveyor.

FIG. 11 is a view in perspective illustrating the present invention.

FIG. 12 is a view in perspective illustrating the present invention with the mounting apparatus partially removed to illustrate the underlying structure.

FIG. 13 is a view in perspective illustrating the present invention from the side opposite the FIG. 12 view.

FIG. 14 is a view in perspective illustrating a magnified view of the present invention's upper conveyor mounting structure.

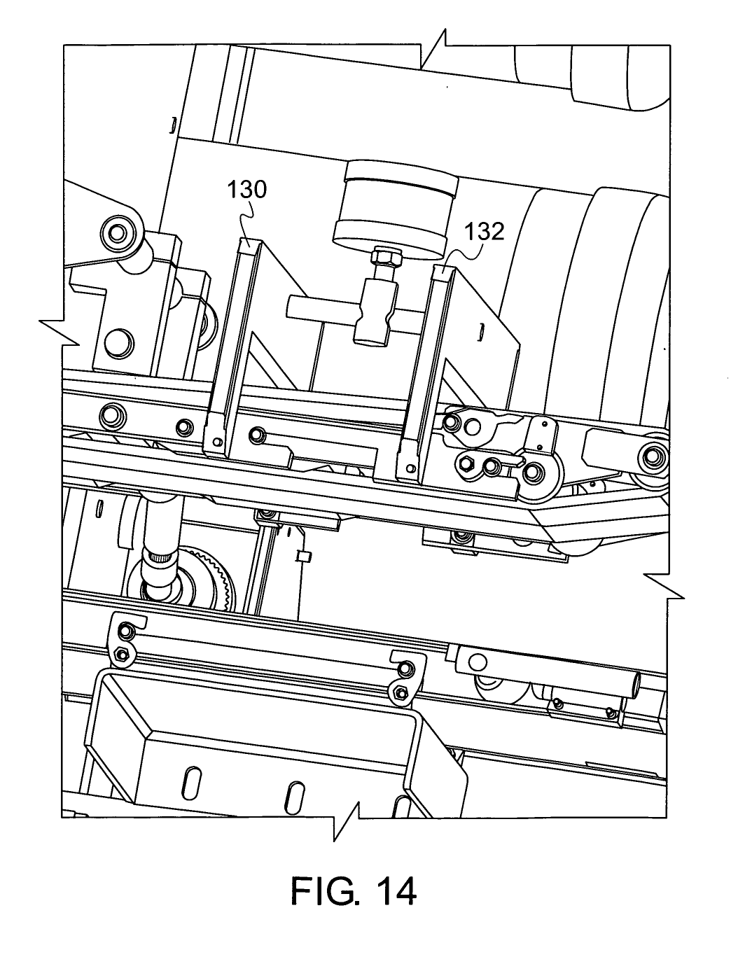

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

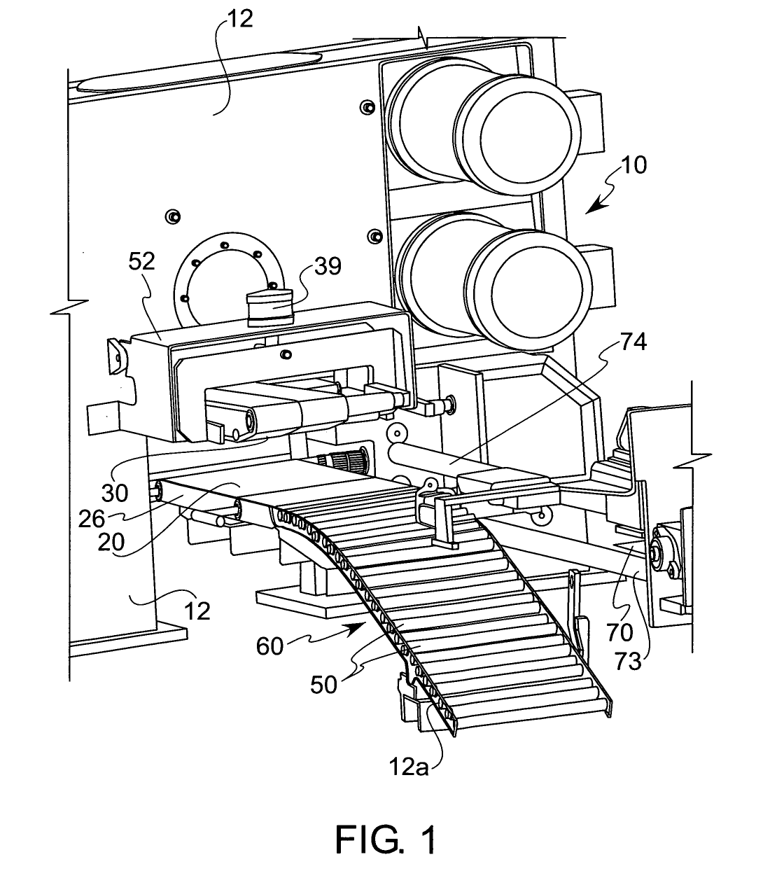

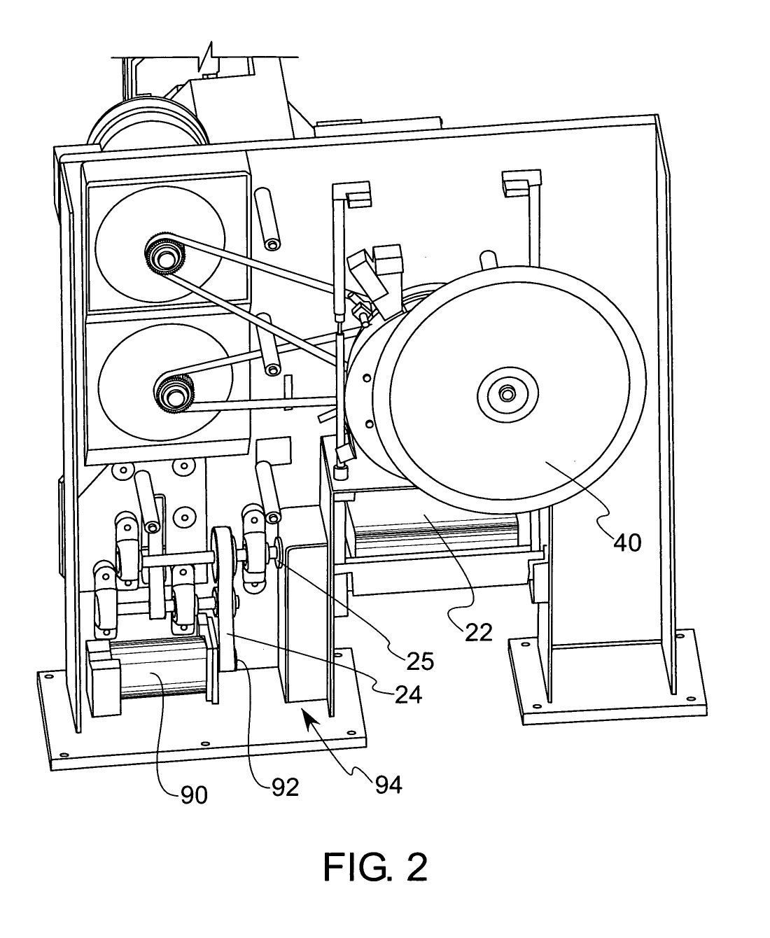

The food slicing machine 10 is shown in FIG. 1. The machine has two modes: continuous and gripper, which are described in detail below. The machine is shown in the continuous feed mode in FIG. 1. The lower conveyor 20 is mounted to the frame 12 in a conventional manner for conveyor belts. The conveyor belt 22 forms the food-supporting surface of the lower conveyor 20 around the rollers rotatably mounted at opposing ends of the conveyor frame 26. A timing or cog drive belt 24 (FIG. 2) is drivingly linked to the shaft 25, which is connected to the roller that drives the endless conveyor belt 22. The drive belt 24 is a toothed belt that extends around a gear on the drive shaft of the electric servo motor 90 mounted to the frame 12 (FIG. 2), but could be replaced by equivalent drive mechanisms, including pulleys and belts, gears and drive shafts or gears and chains, as is understood for drive mechanisms. The servo motor 90 can be replaced by other equivalent drive means, such as a hydraulic motor, pneumatic motor, or other prime mover.

The servo motor 90 is preferably contained in a sealed housing 94 in order that food particles and washing solution do not contact it during ordinary use. The housing 94, some components of which are not shown in FIG. 2 to make the underlying mechanism visible, incorporates portions of the frame 12. The driveshaft 25 preferably extends through the housing 94 sidewall via a seal that prevents or reduces water infiltration into the housing.

The servo motor 90 preferably has its drive gear 92 oriented with its axis perpendicular to the length of the lower conveyor 20. When the servo motor 90 engages, it drives the top surface of the endless belt 22 to convey food products in one direction, but the servo motor 90 can be reversed to drive the belt 22 in the opposite direction.

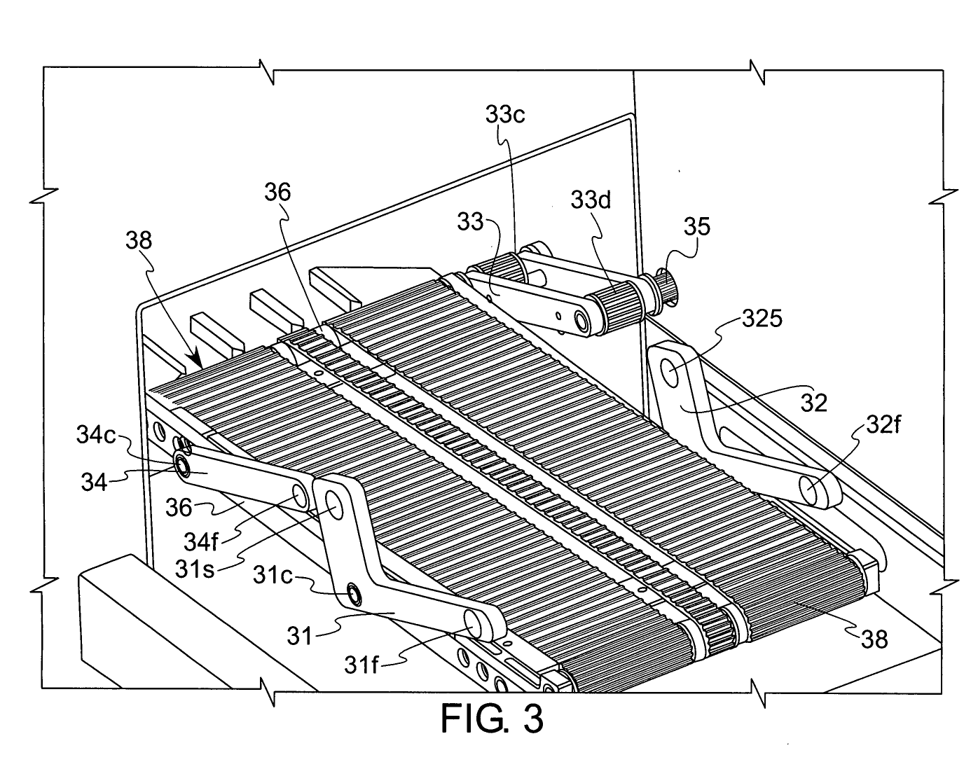

The upper conveyor 30 (FIGS. 1 and 3) is mounted to the frame 12 in a manner that permits vertical displacement thereof, such as by pivotably mounting the linkage members 31, 32, 33 and 34 near one of their ends to the frame 12 and near the other of their ends to the frame 36 of the upper conveyor 30 (see FIG. 3). The members 31-34 pivotably mount to the upper conveyor 30 at points 34c and 31c, and similar points on members 32 and 33. The members 31-34 pivotably mount to the frame 12 at points 31f, 32f and 34f.

The member 33 extends between the drive shaft 33d and the driven shaft 33c, which rotate to drive the conveyor belts 38. The member 33 can pivot about the axes of the two shafts 33d and 33c, thereby creating no interference with the vertical displacement of the conveyor 30. The drive shaft 33d is mounted to the spline shaft 35, which is driven by drive means, preferably the same servo motor 90 that drives the lower conveyor 20. The spline shaft 35 preferably extends through the housing 94 via a seal.

The axis of the spline shaft 35 is not displaced vertically, even when the conveyor 30 is displaced vertically, and therefore the drive motor or linkage to the drive motor does not need to be vertically displaceable. Instead, a timing belt (not shown) extends from the drive shaft 33d to the driven shaft 33c, and thereby drives the driven shaft 33c. The driven shaft 33c is drivingly linked to the roller 36 around which the belts 38 extend, preferably by having the axis of the driven shaft 33c coincident with the axis of the roller 36. Thus, upon rotation of the servo motor 90, the spline shaft 35 rotates, thereby rotating the drive shaft 33d, the timing belt, the driven shaft 33c, the roller 36 and the belts 38. And as the upper conveyor is displaced vertically, the distance between the axes of the drive shaft 33d and the driven shaft 33c remains the same, thereby causing no negative effect on the driving of the upper conveyor 30.

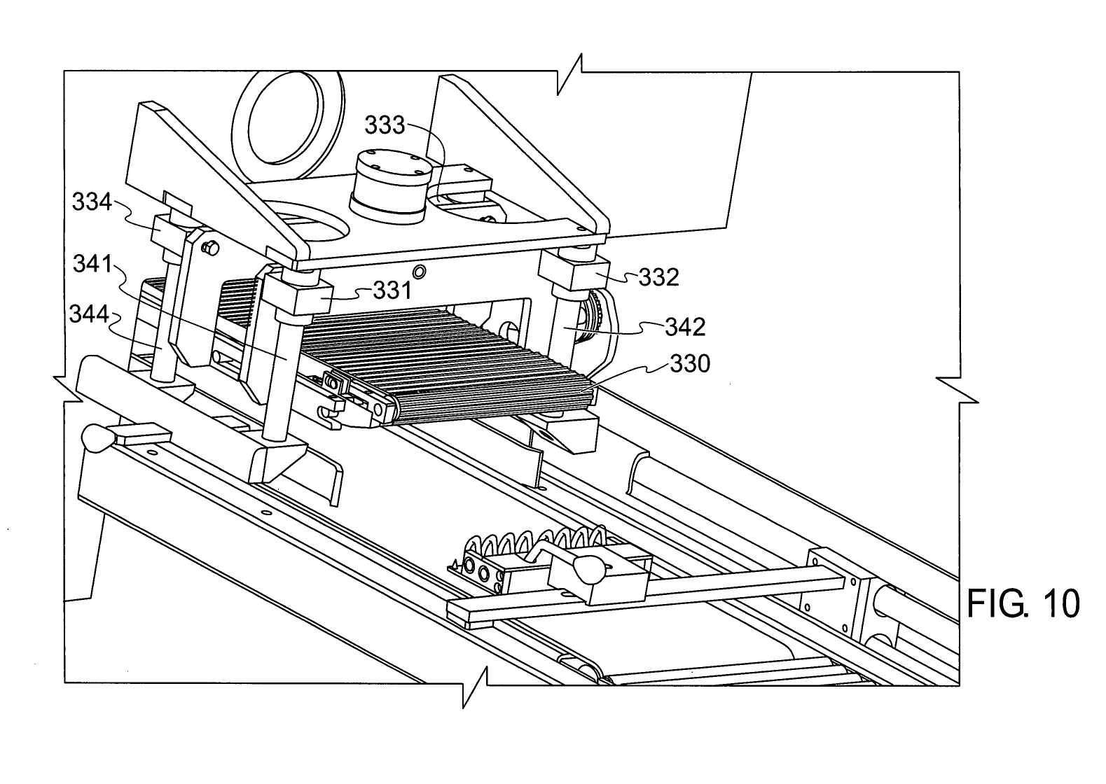

As an alternative to the vertically displaceable conveyor mechanism described above, the mechanism shown in FIG. 10 could be used. The FIG. 10 mechanism includes an upper conveyor 330 mounted to the bearings 331, 332, 333 and 334 which are slidably mounted on vertical rods 341, 342, 343 (not visible in FIG. 10) and 344, respectively. The vertical movement of the upper conveyor 330 occurs as the bearings 331-334 slide along the rods 341-344. Other alternatives to the vertically displaceable upper conveyor are also contemplated.

It should be noted that, as is conventional, the spans of the belts of the upper conveyor 30 and the lower conveyor 20 that seat against the food product are synchronously driven in the same direction when the apparatus is in continuous feed mode. Thus, both conveyors feed food product into the blade, or away from the blade if necessary, such as to dislodge food or to hold food away from the blade during a pause between slicing events. In order to drive both conveyors synchronously with the same motor, the drive direction of one of the drive mechanisms must be reversed. The driveshaft 25 can have its direction of rotation reversed by conventional gearing, the reverse side of a two-sided toothed belt or any other conventional mechanism. Alternatively, the upper conveyor's direction can be reversed by the two-sided toothed belt as shown in FIG. 2.

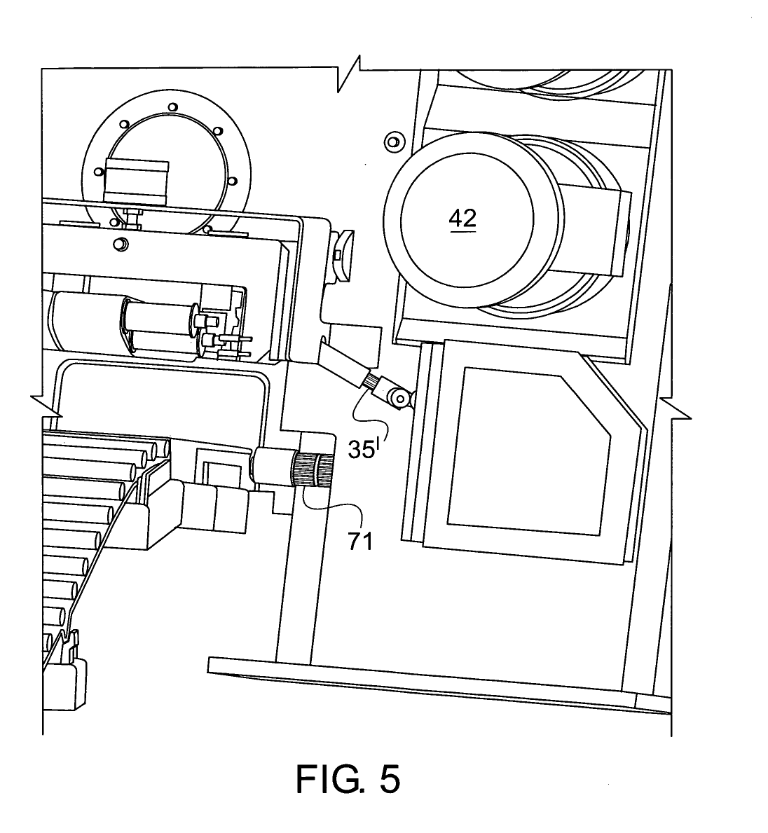

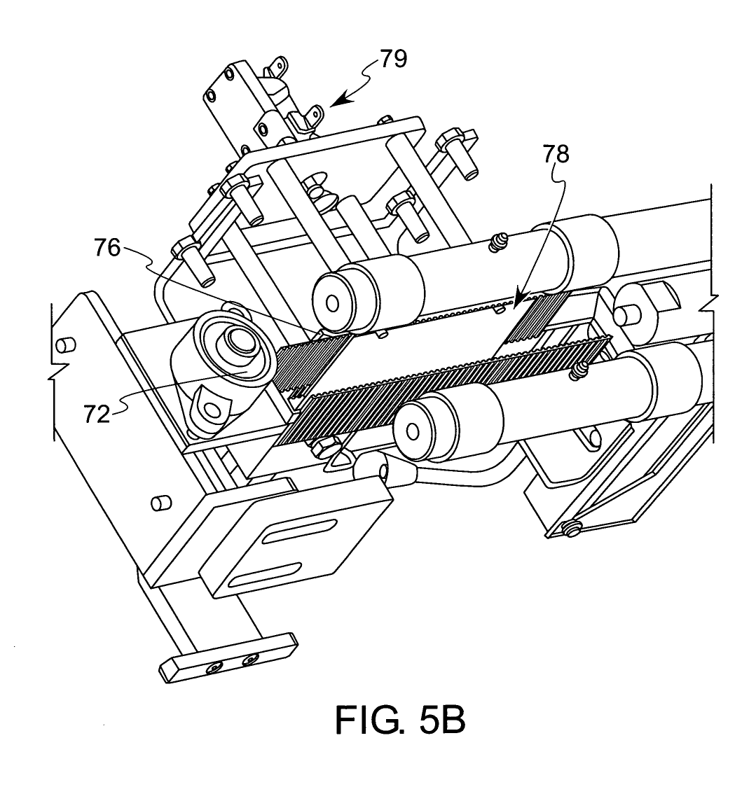

The blade 40 (FIG. 2) is mounted in a conventional manner and is driven by its own drive motor 42 (FIG. 5) with the center of the circular blade 40 offset from the drive motor's driveshaft to provide movement of the blade's sharp, outer edge around a path that is larger than the blade's diameter. As shown in FIG. 2, the blade 40 is in a position that permits food product to be fed through the food path between the conveyors 20 and 30 and into the blade's cutting path at this stage in the blade's revolution. Before the blade rotates further and begins to enter the food path again, the food product is advanced into the blade's cutting path, and, when the blade advances farther, a food slice is formed. The blade, its drive motor and its cutting method are conventional.

As described above, the upper conveyor 30 utilizes linkage members 31-34 pivotably mount to the frame 12 at points that are spaced from complementary pivot points on the upper conveyor's 30 frame 36. Because of this structure, the upper conveyor 30 can be displaced vertically, such as when food product is disposed in the space between the upper and lower conveyors. When the upper conveyor 30 is displaced downwardly from the position shown in FIG. 3, its motion follows an arcuate path that extends downwardly and away from the blade 40. This is due to the pivoting linkage members 31-34. A force generating drive means, such as a spring or pneumatic ram 39 (FIG. 1), can be drivingly linked to the legs of the members 31 and 32 where the pivots 31s and 32s, respectively, are formed in order to apply a force to the pivots 31s and 32s that is at a right, or substantially right, angle to the legs of the members 31 and 32. Such a force generates a torque in the members 31 and 32 that tends to raise or lower at least the end of the conveyor 30 that is farthest from the blade 40. Raising the conveyor 30 increases the space between the conveyors 20 and 30 to accommodate a larger food product, whereas applying a downward force to the conveyor 30 will either decrease the space between the conveyors or increase the force on a food product therebetween.

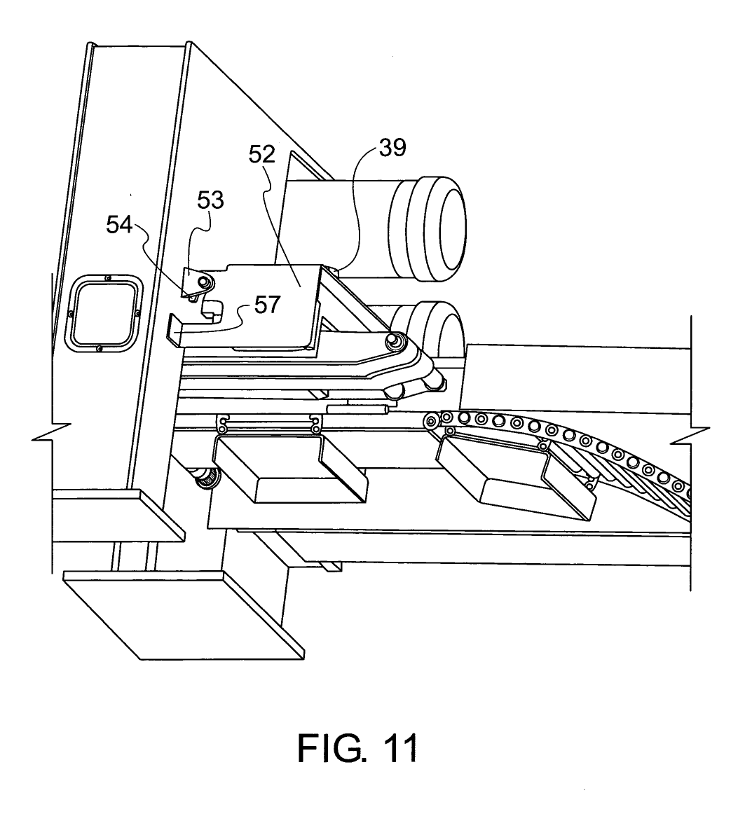

As noted above, the mounting apparatus 52 shown in FIG. 1 attaches to the frame 12. As is more clearly shown in FIG. 11, the mounting apparatus 52 has a hook 54 that extends over a pin that extends inwardly from the ear 53 that protrudes from the frame 12. A similar hood, ear and pin are formed on the opposite side of the mounting apparatus 52, but are not visible in the figures. A tab 57 seats against the frame 12, and a similar tab (not visible) is formed on the opposite side of the mounting apparatus 52. It is contemplated, although not required, that pins will extend outwardly from the frame 12 into apertures formed in the tabs. In order to remove the mounting apparatus 52, one pivots the upstream end thereof upwardly to rotate the tabs away from the frame, and then lifts to unhook the hooks from the pins on the ears that protrude from the frame.

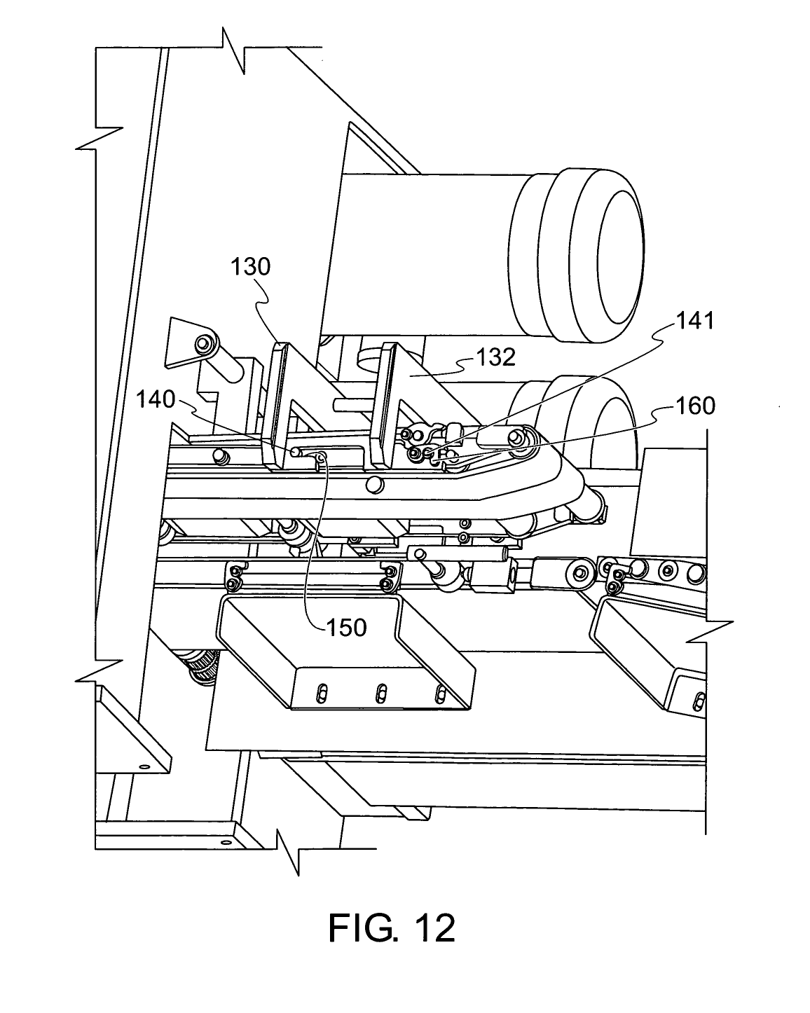

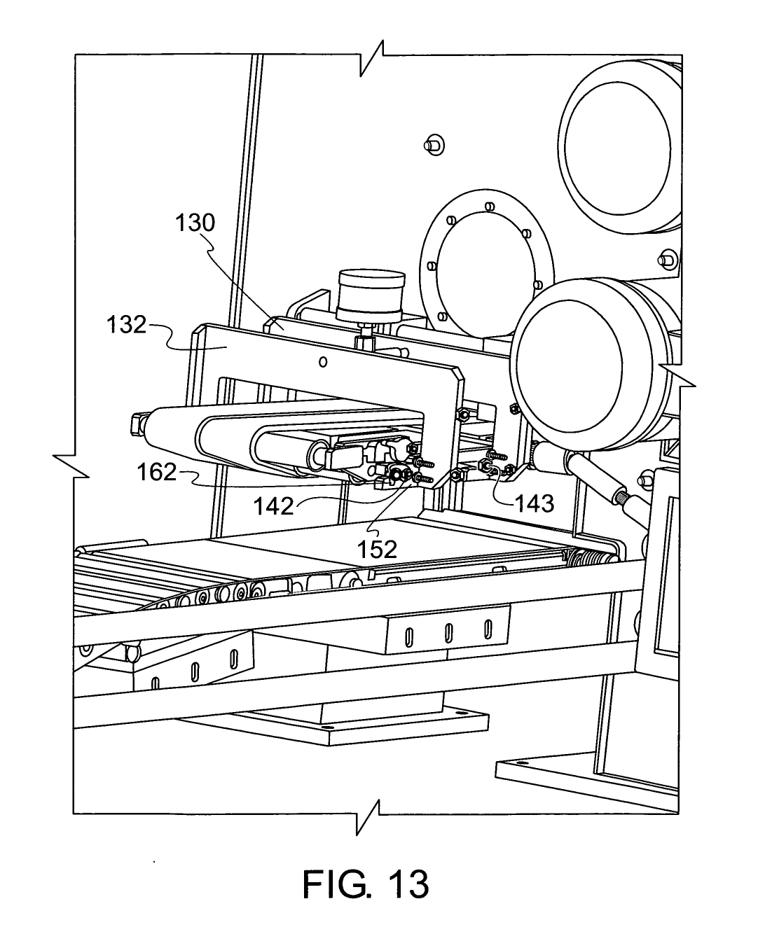

The embodiment shown in FIG. 11 includes the attachment of the upper conveyor 30 by a much simpler mechanism than that shown in FIG. 3. In the embodiment of FIG. 11, the pneumatic ram 39 mounts to the mounting apparatus, and extends downwardly to a pair of inverted U-shaped arms 130 and 132 that extend downwardly to the sides of the upper conveyor 30. The arms are shown clearly in FIGS. 12 and 13, which have the mounting apparatus 52 removed for clarity. The ram 39 displaces the arms 130 and 132 as desired, and can apply a downward force on the arms 130 and 132 in order to increase the force on the food product between the conveyors.

The pins 140, 141, 142 and 143 extend laterally outwardly from the sides of the upper conveyor frame and insert into slots formed in the brackets 150 and 152 mounted to the arms 130 and 132. Thus, the conveyor 30 is mounted to the machine by inserting the pins 140 and 143 into the downstream slots on the brackets 150 and 152, the pins 141 and 142 are aligned with the upstream slots on the brackets, and the conveyor frame is slid downstream to the full extent of the slots.

Because the brackets 150 and 152 are mounted to the arms 130 and 132, the conveyor is mounted to the mounting apparatus 52, and therefore the frame 12, by installing it as described. Rotatable hooks 160 and 162 are mounted to the brackets 150 and 152 to hook around the pins 141 and 142 when the conveyor is in its installed position, thereby preventing unintentional removal from the brackets 150 and 152. Removal is accomplished by simply unhooking the hooks 160 and 162, sliding the conveyor 30 in the upstream direction and dropping it downwardly for removal.

Of course, the arrangement described above for the attachment of the upper conveyor could be combined with the embodiment shown in FIG. 3, such as by extending pins from the members 31-34 that insert into slots in brackets similar to the brackets 150 and 152.

Referring again to FIG. 1, the moveable roller frame 60 has rollers 50 mounted on low-friction bearings. The moveable roller frame 60 is a rigid member removably mounted to the frame 12 by connectors at its opposing ends. The moveable roller frame 60 is substantially planar, but has a curved end that forms a gentle transition between the rollers 50 and the lower conveyor 20 when the machine 10 is in the continuous mode, as described below. Preferably, the moveable roller frame 60 is tilted toward the frame 12 in a conventional manner to encourage food products placed on the rollers 50 to roll downhill toward the conveyors 20 and 30. Upon contacting the conveyors 20 and 30, the food product is grasped by the driven belts thereof and driven along the food path toward the blade to be sliced in a conventional manner.

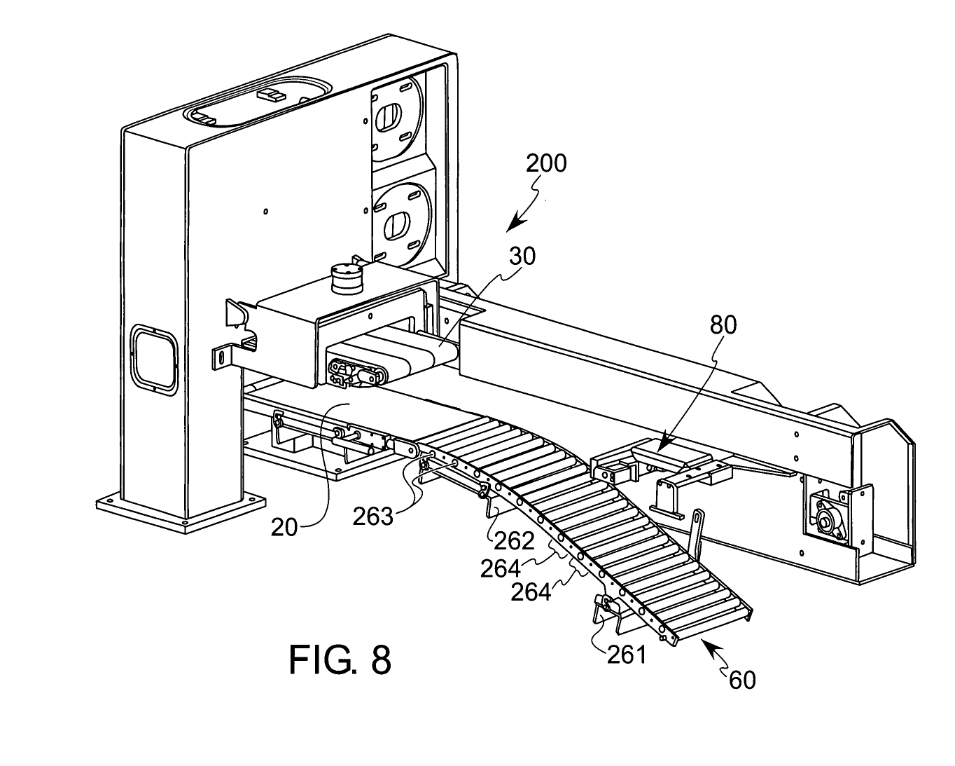

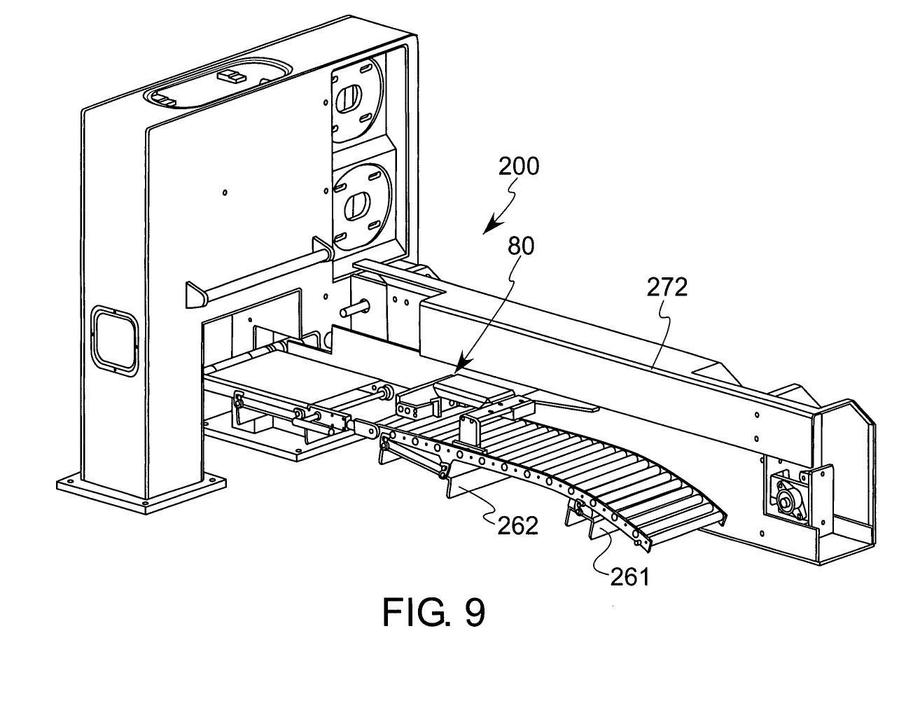

The moveable roller frame 60 is mounted to the frame 12 with its planar section oriented substantially parallel to and coplanar with the lower conveyor 20 and with the curved end farthest from the lower conveyor 20 during the gripper mode (FIG. 9). The roller frame 60 can be removed from the frame 12, rotated 180 degrees and re-attached with the curved end mounted to the frame 12 at the upstream end of the lower conveyor 20 so that the continuous feed mode (FIGS. 1 and 8) can be engaged. The dual-positioning feature permits the same moveable roller frame 60 to be mounted in one position, spaced beneath the gripper mechanism to allow end loading of the rollers 50 without interference from the gripper mechanism, and then be moved to a second position in which the gripper mechanism is adjacent to, and moves food products along, the rollers 50. During the continuous mode, the moveable roller frame 60 is spaced far enough below the gripper that the food products on the rollers 50 are spaced from the gripper. The curvature near the connection to the lower conveyor 20 provides a gentle transition between the planar section and the upstream end of the planar lower conveyor 20.

During the gripper mode, the planar region of the moveable roller frame 60 is substantially coplanar with the lower conveyor 20. The curved end is placed outside of the range of the gripper. Therefore, the rollers 50 are directly beneath the gripper during the gripper mode so that food on the rollers 50 can be displaced by the gripper.

In an alternative embodiment, the moveable roller frame is completely planar and pivotably mounts to the frame 12 at one end. In another alternative, the moveable roller frame is a multi-piece structure with pivots along its length which permit the components thereof to pivot relative to one another in the manner of a bicycle chain. In this alternative, the roller frame sections pivot relative to one another to form any desired shape. Thus, in order to move the moveable roller frame from its position during the gripper mode to its position during the continuous feed mode, structures that support this alternative roller frame are moved and the roller frame sections pivot to form the curved moveable roller frame below the gripper mechanism.

The term “food path” is defined herein as the path that food products traverse when they are driven toward the blade 40. The food path need not be a straight line, and can change when the configuration of the machine changes from one feed mode to another. For example, in the continuous feed mode, the food path extends along the moveable roller frame 60 between the conveyors 20 and 30 and into the blade 40. In the gripper mode, the food path extends from the gripper head on the rollers 50 over the lower conveyor and into the blade.

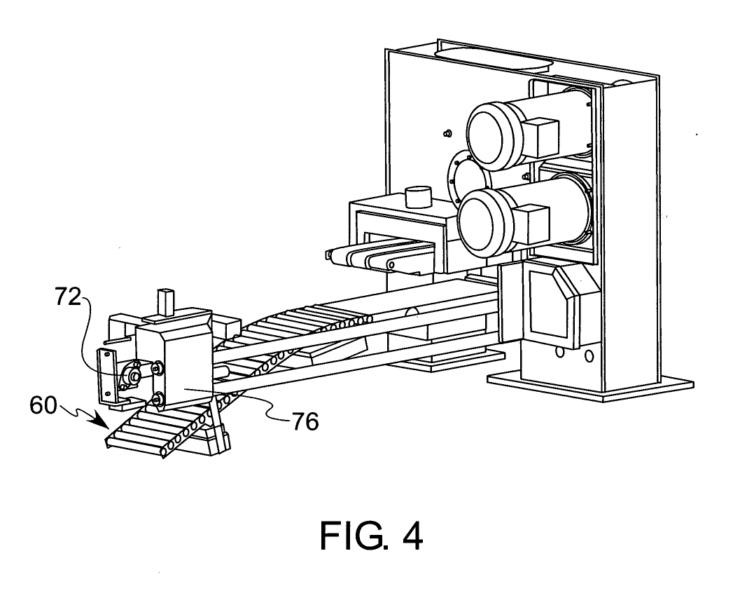

Referring again to FIG. 1, the drive belt 70 is driven by a prime mover, preferably the electric servo motor 90 that drives the conveyors 20 and 30. The drive belt 70 preferably extends from the driven gear 71 that is on the driveshaft 25 (FIG. 5) to the idler gear 72 (FIGS. 4 and 5b) that mounts to the frame 12 with a low-friction bearing. Thus, upon rotation of the driven gear 71, the belt 70 is displaced.

A pair of parallel bars 73 and 74 extend from the frame 12 and have very smooth outer surfaces against which the bearings (FIG. 5b) of the gripper base 76 seat. Thus, the gripper base 76 can be displaced linearly along a path parallel to the bars 73 and 74 with little resistance. The gripper base 76 has a clutch mechanism, preferably a jaw 78 (FIG. 5b) that opens and closes by actuation of the lever 79. This clutch mechanism engages and disengages the drive belt 70, which is also referred to herein as “linking and unlinking” the gripper to the gripper drive means, by clamping the drive belt 70 in the jaw 78. The jaw has a lower surface (not shown) with mating teeth that correspond to the cog teeth on the inside of the belt 70. Thus, by engaging the clutch mechanism, the jaw 78 is closed to the position shown in FIG. 5. By disengaging the clutch, the jaw 78 is opened and the belt 70 is released from the jaw 78. In the preferred embodiment, the belt 70 is displaced whenever the servo motor 90 is driven. However, only when the jaw 78 is in the clutched state does the gripper base 76 move with the belt 70 whenever the belt 70 is driven. By releasing the belt 70, the gripper base 76 remains stationary, even when the motor 90 drives the belt 70.

It is contemplated for a less preferred embodiment that the gripper base 76 have other drive means, such as a motor, separate from the servo motor 90 that drives the upper and lower conveyors. In this embodiment, the gripper drive means can be actuated when it is desired to move the gripper base. In another contemplated embodiment, an actuatable clutch engages and disengages a drive pulley that drives the gripper drive belt, thereby permitting engagement and disengagement of the belt by engaging or disengaging the actuatable clutch.

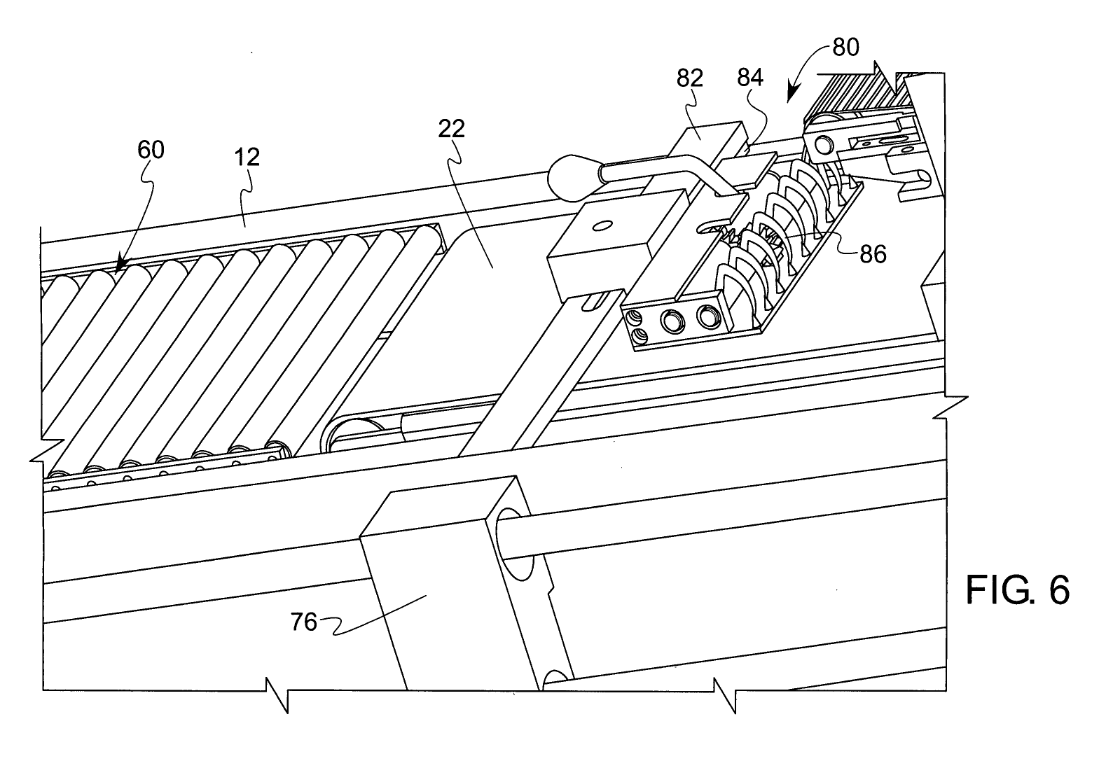

A gripper head 80 is attached to the gripper base 76 when the apparatus 10 is operational, notwithstanding the deliberate omission of the gripper head from some of the figures for clarity in illustrating the underlying structures. The gripper head 80 is a conventional gripper head that grips food product loafs using teeth 86, and is rigidly mounted to the gripper base 76 as shown in FIG. 6. A bar 82 rigidly attaches to the gripper base 76 and extends to the opposite side of the lower conveyor 20. Thus, the gripper head 80 is spaced just above the lower conveyor's belt 22. Conventional grippers of any suitable type can be used in place of the grippers described herein, as will be apparent to the person having ordinary skill.

When the gripper base 76 is displaced longitudinally along the bars 73 and 74, the gripper head 80 is likewise displaced along the rollers 50 just above the lower conveyor's belt 22. Any food product gripped by the gripper head 80 is thereby displaced along the same path. Preferably, the lower conveyor's belt 22 is displaced at the same rate and in the same direction as the gripper head 80 during gripper mode, because the driven gear 71 is mounted on the driveshaft 25, and thereby simultaneously drives the lower conveyor 20 and the belt 70.

It is contemplated that, when food is in the gripper head 80, the gripper head 80 will be displaced toward the blade 40 in a conventional manner, such as by displacing the far end of the food product into the blade's cutting path. When cutting begins, the gripper head 80 is then indexed toward the blade's cutting path, either continuously or in small distances equal to the desired slice thickness, as is conventional. When cutting ceases, the gripper head 80 automatically or by operator actuation, releases any heel and discards it in a conventional manner. Then the gripper head 80 returns to the loading position and receives a new food product. It is preferred that a central computer, to which the servo motor 90, a sensor on the latch 79 and other components of the machine 10 are connected, controls the components of the machine 10 to prevent impact between components thereof, such as the gripper. Additionally, sensors are used to detect the position of the gripper head, the orientation of the roller frame 60 and other components to enhance safety.

As shown in FIG. 9, the shield 272 shields the drive belt and remainder of the drive mechanism (not shown) for the gripper mechanism 80 from food particles and washing spray. The drive arm for the gripper mechanism 80 extends from behind the shield 272.

When it is desired for the gripper head 80 to no longer be used, such as when it is desired to begin the continuous feed mode, the servo motor 90 is actuated to drive the belt 70 so that the attached gripper base 76 and the gripper head 80 are driven to a pre-determined position that is far away from the blade 40, such as the position of the gripper base 76 shown in FIGS. 4 and 8. The gripper head 80 thus remains mounted to the gripper head 76 as described above and shown in FIG. 6 when the gripper base 76 is driven to the position shown in FIGS. 4, 5b and 8. An illustration of an entire machine in the gripper mode is shown in FIG. 8. When driven to this position, the gripper base 76 disengages the clutch, which opens the jaw 78 to release the belt 70 to move independently of the gripper base 76. The clutch remains disengaged during the entire time that the gripper head 80 is not used, which is during the continuous feed mode. The gripper base 76 and gripper head 80 are thereby “parked” in this position distal to the blade 40, which is out of the way of the remainder of the apparatus that is used in continuous feeding of food products into the blade 40.

As noted above, before engaging the continuous feed mode, the moveable roller frame 60 is removed, rotated 180 degrees and re-attached at its opposite end to the frame 12 so that food products can be end-loaded onto the rollers 50 for feeding to the conveyors 20 and 30. The rollers 50 remain beneath the gripper head 80, and they are spaced a significant distance from the gripper head 80 so that the gripper head 80 does not interfere with the end-loading of the apparatus. The moveable roller frame 60 thus forms a “window” through which food products can be fed, where the gripper mechanism is at the top of the window and out of the way of food loading.

It will become apparent that the invention is a cutting machine that can be used in one of two different modes: a continuous feed mode and a reciprocating gripper mode. In the continuous feed mode shown in FIGS. 1 and 8, the gripper head 80 is “parked” far from the blade and the moveable roller frame 60 is positioned far enough beneath the gripper head 80 that it does not interfere with loading of the food path. In this configuration, food products can be end-loaded onto the rollers 50 of the moveable roller frame 60, and the food products will roll to the upper and lower conveyors, which drive food product into the blade 40. The gripper head 80 is parked above the moveable roller frame 60, and is therefore not in the way of end-loading of the food path. Because the gripper base 76 is not clutched to clamp the belt 70, the belt can continue to be displaced by the servo motor by simply sliding through the jaw 78. In this continuous feed mode, the drive belt 70 may still be displaced by the servo motor 90, but it does not drive the gripper head 80 due to release of the belt 70 by the jaw 78.

When the apparatus is in the continuous mode, the substantially planar region of the moveable roller frame 60 is angled relative to the lower conveyor 20. The curved end of the frame 60 forms a gentle transition between the planar section of the frame 60 and the planar lower conveyor 20, thereby easing the flow of food products onto the lower conveyor 20.

When it is desired to use the gripper head 80 to grip food products, the gripper mode is engaged. Before entering this mode, the roller frame 60 is removed, turned 180 degrees and attached to the frame 12 in the position shown in FIG. 9. To enter the gripper mode, the gripper base 76 actuates the clutch, which grips the belt 70 with the jaw 78. The servo motor 90 then drives the gripper head 80 to a loading position, preferably near the end of the lower conveyor 20 that is farthest from the blade 40 as shown in FIG. 9. A food loaf is then gripped by the gripper head 80 in a conventional manner and the gripper head 80 and lower conveyor 20 are indexed toward the blade 40.

It is preferred that in the gripper mode, the upper conveyor 30 is removed in order to reduce wear on the upper conveyor 30, in order to reduce drag on the servo motor 90, in order to increase the space above the lower conveyor 20 or for any other reason, such as for cleaning. When the upper conveyor is removed, the mounting apparatus 52 (FIG. 1) is also preferably removed to provide substantial clearance. If the upper conveyor is removed, a small diameter nose roller (not shown) can be attached in its place to exert pressure on the top of the food product just before it is sliced, thereby maintaining the food product's position during slicing. Alternatively, the upper conveyor 30 can simply be retracted to a position that does not interfere with food products in the food path if sufficient clearance is available. The conversion from the continuous feed mode to the gripper mode takes very little time, preferably no more than a few minutes, and preferably can be carried out without tools.

In order to remove the upper conveyor 30 from the FIG. 3 embodiment, the linkage members 31-34 are simply removed from attachment to the frame 12. This is preferably accomplished by removing machine screws, pins or any other structure that is readily withdrawn from an aperture. Then the upper conveyor is simply displaced laterally so that the spline shaft 35 is withdrawn from a spline collar or similar structure that is drivingly linked to the servo motor.

In the gripper mode, the lower conveyor and, in the preferred embodiment, at least the drive mechanism for the upper conveyor continue to be driven by the servo motor 90. The lower conveyor 20 preferably moves toward the blade 40 at the same rate as the gripper head 80.

While certain preferred embodiments of the present invention have been disclosed in detail, it is to be understood that various modifications may be adopted without departing from the spirit of the invention or scope of the following claims.

1. An apparatus for conveying food products along a food path into a blade of a food slicing machine, the apparatus comprising:
(a) a lower conveyor defining a base of the food path and drivingly linked to means for driving the lower conveyor;
(b) an upper conveyor spaced from the lower conveyor, adjacent the food path and drivingly linked to means for driving the upper conveyor at least during a continuous feed mode;
(c) a gripper; and
(d) means for linking the gripper to gripper drive means and disposing the gripper in the food path during a reciprocating gripper mode, and for unlinking the gripper from the gripper drive means and disposing the gripper out of the food path during the continuous feed mode.

2. The apparatus in accordance with claim 1, wherein the lower conveyor's drive means, the upper conveyor's drive means and the gripper drive means are all connected.

3. The apparatus in accordance with claim 2, wherein the lower conveyor's drive means, the upper conveyor's drive means and the gripper drive means include a single drive motor.

4. The apparatus in accordance with claim 3, further comprising:
(a) a plurality of linkage members pivotably mounting the upper conveyor to the food slicing machine;
(b) a first of said linkage members extends between a drive shaft and a driven shaft;
(c) a toothed belt extends from the drive shaft to the driven shaft;
(d) a roller of the upper conveyor is drivingly linked to the driven shaft; and
(e) the first linkage member has pivot points that coincide with axes of the drive shaft and the driven shaft.

5. The apparatus in accordance with claim 1, further comprising a moveable roller frame that extends from near one end of the lower conveyor to beneath the gripper for conveying food products from beneath the gripper to the lower conveyor.

6. The apparatus in accordance with claim 1, further comprising a moveable roller frame that extends from near one end of the lower conveyor to beneath the gripper for conveying food products with the gripper on the lower conveyor.

7. The apparatus in accordance with claim 1, further comprising a moveable roller frame with opposing first and second ends, the first end having a connector removably mounted to the lower conveyor, the second end extending beneath the gripper and having a connector for mounting to the lower conveyor.

8. The apparatus in accordance with claim 7, wherein the first end of the moveable roller frame is substantially planar and the second end is curved.

9. An apparatus for conveying food products along a food path into a blade of a food slicing machine, the apparatus comprising:
(a) a lower conveyor defining a base of the food path and drivingly linked to a motor that drives the lower conveyor;
(b) a vertically displaceable upper conveyor removably mounted above the lower conveyor and removably, drivingly linked to the motor at least during a continuous feed mode;
(c) a gripper; and
(d) a clamping jaw connected to the gripper for clamping a drive belt driven by the motor and disposing the gripper in the food path during a reciprocating gripper mode, and for releasing the drive belt and disposing the gripper out of the food path during the continuous feed mode.

10. The apparatus in accordance with claim 9, further comprising:
(a) a plurality of linkage members pivotably mounting the upper conveyor to the food slicing machine;
(b) a first of said linkage members extends between a drive shaft and a driven shaft;
(c) a toothed belt extends from the drive shaft to the driven shaft;
(d) a roller of the upper conveyor is drivingly linked to the driven shaft; and
(e) the first linkage member has pivot points that coincide with the axes of the drive shaft and the driven shaft.

11. The apparatus in accordance with claim 9, further comprising a moveable roller frame that extends from near one end of the lower conveyor to beneath the gripper for conveying food products from beneath the gripper to the lower conveyor.

12. The apparatus in accordance with claim 9, further comprising a moveable roller frame that extends from near one end of the lower conveyor to beneath the gripper for conveying food products with the gripper on the lower conveyor.

13. The apparatus in accordance with claim 9, further comprising a moveable roller frame with opposing first and second ends, the first end having a connector removably mounted to the lower conveyor, the second end extending beneath the gripper and having a connector for mounting to the lower conveyor.

14. The apparatus in accordance with claim 13, wherein the first end of the moveable roller frame is substantially planar and the second end is curved.

15. A method for continuously conveying food products along a food path into a slicing blade of a food slicing machine, the method comprising:
(a) disposing a lower conveyor at a base of the food path;
(b) drivingly linking the lower conveyor to means for driving the lower conveyor;
(c) spacing an upper conveyor from the lower conveyor adjacent the food path;
(d) drivingly linking the upper conveyor to means for driving the upper conveyor;
(e) disposing a gripper on the machine out of the food path; and
(f) unlinking the gripper from means for driving the gripper.

16. The method in accordance with claim 15, further comprising drivingly linking the gripper to means for driving the gripper and disposing the gripper in the food path.

17. The method in accordance with claim 15, wherein the steps of drivingly linking the gripper and disposing the gripper further comprise clamping a jaw that is connected to the gripper on a drive belt and then displacing the belt.

18. The method in accordance with claim 15, further comprising mounting a moveable roller frame leading to the lower conveyor beneath the gripper for conveying food products from beneath the gripper to the lower conveyor.

19. A method for conveying food products along a food path into a slicing blade of a food slicing machine, the method comprising:
(a) disposing a lower conveyor at a base of the food path;
(b) drivingly linking the lower conveyor to means for driving the lower conveyor;
(c) disposing a gripper into the food path; and
(d) drivingly linking the gripper to means for driving the gripper.

20. The method in accordance with claim 19, further comprising:
(a) spacing an upper conveyor from the lower conveyor adjacent the food path; and
(b) drivingly linking the upper conveyor to means for driving the upper conveyor.

21. The method in accordance with claim 20, further comprising unlinking from the upper conveyor the means for driving the upper conveyor.

22. The method in accordance with claim 21, further comprising removing the upper conveyor from adjacent the food path.

23. The method in accordance with claim 21, further comprising raising the upper conveyor, thereby spacing the upper conveyor further from the lower conveyor.

24. The method in accordance with claim 20, further comprising raising the upper conveyor, thereby spacing the upper conveyor further from the lower conveyor.

25. The method in accordance with claim 20, further comprising mounting a moveable roller frame leading to the lower conveyor beneath the gripper for conveying food products from the gripper to the lower conveyor.

26. A primarily vertically displaceable conveyor for conveying food products on a food slicing machine, the conveyor comprising:
(a) at least first and second rollers rotatably mounted to a conveyor frame and around which an endless loop belt extends;
(b) a plurality of linkage members pivotably mounted to the frame at a plurality of points and pivotably mounted to the food slicing machine at a plurality of spaced points;
(c) a drive shaft drivingly linked to means for driving the conveyor and having an axis coincident with one of said pivot points in a first of said linkage members, wherein the first roller's axis is coincident with a second of said pivot points in the first linkage; and
(d) a belt drivingly linking the drive shaft with the first roller.

27. A removable conveyor for conveying food products on a food slicing machine, the conveyor comprising:
(a) at least first and second rollers rotatably mounted to a conveyor frame and around which an endless loop belt extends;
(b) at least three pins extending from the conveyor fame;
(c) a first bracket mounted to at least a first of the pins, and a second bracket mounted to at least a second of the pins; and
(d) an arm removably mounted to a prime mover for displacing the arm vertically, and to which at least the first bracket is mounted;
wherein the prime mover is removably mounted to the food slicing machine.

28. The removable conveyor in accordance with claim 28, wherein the prime mover is mounted to a mounting apparatus that is removably mounted to the food slicing machine, the arm further comprises first and second arms that extend downwardly from the mounting apparatus to opposite sides of the conveyor frame, the first bracket is mounted to the first and second arms on a first side of the conveyor frame, and the second bracket is mounted to the arms on the opposite side of the conveyor frame.

29. The removable conveyor in accordance with claim 29, further comprising fastening means extending around the pins for retaining the pins.
